(19) United States
(12) Patent Application Publication
(10) Pub. No.: US 2025/0354627 A1
(43) Pub. Date: Nov. 20, 2025

(54) Wire Clip Design for Cable Management

(71) Applicant: Maxeon Solar Pte. Ltd., Singapore (SG)

(72) Inventors: Jianxun Wu, Hubei Province (CN); Yafu Lin, Pleasanton, CA (US); Yonggang Guo, Baoding (CN)

(73) Assignee: Maxeon Solar Pte. Ltd., Singapore (SG)

(21) Appl. No.: 18/665,547

(22) Filed: May 15, 2024

(51) Int. Cl. F16L 3/06; F16L 3/24

(52) U.S. Cl. CPC F16L 3/06; F16L 3/24

(57) ABSTRACT

A photovoltaic module cable clip is disclosed. The photovoltaic module cable clip includes a first portion that is configured to fasten to a flange of a frame of a photovoltaic module, a second portion that is configured to fasten to an outside wall of the frame of the photovoltaic module, and a third portion that extends vertically from the first portion and the second portion and is configured to accommodate a cable.

### TECHNICAL FIELD

Embodiments of the disclosure pertain to wire cable clips, and more particularly to wire cable clips for managing photovoltaic module cables.

### BACKGROUND

Proper cable management is vital to the health of a photovoltaic system. Wiring, in photovoltaic systems, which has no standard warranties, is likely to be the first component of the system to have problems or fail completely. Damaged wire insulation can lead to ground faults, system downtime, and fires. Poor wire management can increase the frequency of service calls, which can be expensive.

There are many potential issues that can arise when wires and cables aren't properly managed. For example, they can be subject to extreme temperatures and the direct effects of sunlight, wind, snow and rain. Moreover, sharp panel and mounting system edges can score cables, and roof shingles can abrade insulation with continual rubbing. Rodents that utilize the shade of solar panels can damage dangling wires. Such damage not only jeopardizes the system's reliability, but also its safety.

Properly securing photovoltaic module cables is critical to the productivity, longevity and safety of photovoltaic modules. Properly securing photovoltaic module cables helps to promote productivity, longevity and safety by ensuring that cables are shielded from sun, rain and wind as well as abrasions and scoring. It also eliminates hanging wires that attract animals that can chew on the hanging wires and cause damage. When wires are not properly managed, they can contact roof surfaces which can raise the potential that protective coatings and insulating layers that are used to cover the wires can become compromised. For example, unmanaged wires can blow in the wind and rub rough surfaces in a manner that can cause ground faults, loss in power, or dangerous conditions such as arc faults.

### BRIEF DESCRIPTION OF THE DRAWINGS

FIG. 1A illustrates an exemplary operating environment of photovoltaic modules that utilize wire clips for cable management according to one embodiment.

FIG. 1B shows photovoltaic modules that include cables that are managed using wire clips according to one embodiment.

FIG. 1C shows a perspective view of a photovoltaic module cable clip according to one embodiment.

FIG. 1D shows a side view of a photovoltaic module cable clip according to one embodiment.

FIG. 1E shows a cross sectional view of a cable clip fastened to a frame of a photovoltaic module according to one embodiment.

FIG. 1F shows a view of a cable clip fastened to the underside of a photovoltaic module frame according to one embodiment.

FIG. 1G shows a cross-sectional view of a photovoltaic module frame that has a short frame flange.

FIG. 1H shows a cross-sectional view of a photovoltaic module frame that has a long frame flange.

FIG. 1I shows a conventional cable clip that utilizes a pinch-like hold for clamping to a short frame flange.

FIG. 1J shows a photovoltaic module cable clip for managing cables according to one embodiment.

FIG. 1K shows cables that are not managed in a manner that prevents their exposure to damage according to one embodiment.

FIG. 1L shows cables that are not managed in a manner that prevents their exposure to damage according to one embodiment.

FIG. 2 shows a flowchart of a method of forming a photovoltaic module cable clip according to one embodiment.

### DESCRIPTION OF THE EMBODIMENTS

A wire clip design for cable management is described. It should be appreciated that although embodiments are described herein with reference to example wire clip design implementations, the disclosure is applicable to wire clip design implementations in general as well as other kinds of wire clip design implementations. In the following description, numerous specific details are set forth, such as specific integration and material regimes, in order to provide a thorough understanding of embodiments of the present disclosure. It will be apparent to one skilled in the art that embodiments of the present disclosure may be practiced without these specific details. In other instances, well-known features, are not described in detail in order to not unnecessarily obscure embodiments. Furthermore, it is to be appreciated that the various embodiments shown in the Figures are illustrative and are not necessarily drawn to scale.

Certain terminology may also be used in the following description for the purpose of reference only, and thus are not intended to be limiting. For example, terms such as “upper”, “lower”, “above”, and “below” can refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology as is described here may include the words specifically mentioned above, derivatives thereof, and/or words of similar import.

As used herein, the term “module” is intended to refer to a photovoltaic module or solar panel.

As used herein, the terms “cables” or “wires” are intended to refer to an insulated wire or wires that have a protective casing and that is used to connect the panels of a photovoltaic electric energy system and to convey the electrical energy produced by photovoltaic systems or solar panels back to a collection point or piece of equipment.

As used herein, the term “cable clip” or “wire clip” is intended to refer to a device for holding a cable or wire in place.

Properly securing photovoltaic module cables is critical to the productivity, longevity and safety of photovoltaic modules. It helps to promote safety and durability by ensuring that cables are shielded from sun, rain and wind as well as sharp abrasions and edges. It also eliminates hanging cables that attract animals that can chew on the cables and cause damage. When cables are not properly managed, they can contact roof surfaces and raise the potential that protective coatings and insulation that are used to cover the cable wires are compromised. For example, unmanaged wires can blow in the wind and rub rough surfaces in a manner that causes ground faults, loss in power or dangerous conditions such as arc faults.

A photovoltaic module cable clip is disclosed that addresses the shortcomings of conventional cable clips in properly securing photovoltaic module cables. In one embodiment, the photovoltaic module cable clip described herein includes a first portion that is configured to fasten to a flange of a frame of a photovoltaic module, a second portion that is configured to fasten to an outside wall of the frame of the photovoltaic module, and a third portion that extends vertically from the first portion and the second portion, that is configured to accommodate a cable.

When installed exemplary cable clips can properly secure photovoltaic module cables. This is critical to the productivity, longevity and safety of photovoltaic modules. The operation of the herein described cable clips in properly securing photovoltaic module cables helps to promote safety and durability by ensuring that cables are shielded from sun, rain and wind as well as sharp abrasions and edges. It also eliminates hanging cables that attract animals that can chew on the hanging cables and cause damage. When cables are not properly managed, they can contact roof surfaces which can raise the potential that protective coatings and insulating layers that are used to cover the cable wires are compromised. Utilizing the clips prevents cables from blowing in the wind and rubbing against rough surfaces in a manner that causes ground faults, loss in power or dangerous conditions such as arc faults. The cable clips employ a design that uses less material and is thus is much cheaper than conventional cable clips. In addition, the cable clips have a design that makes them convenient to install.

### Module Cable Management

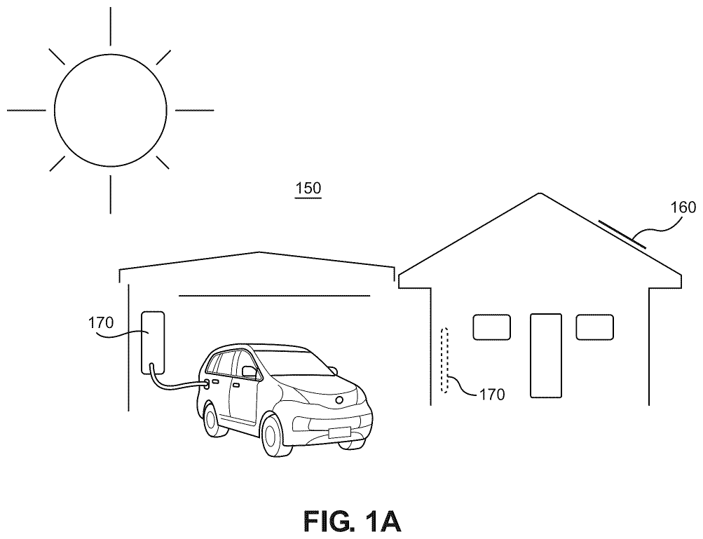

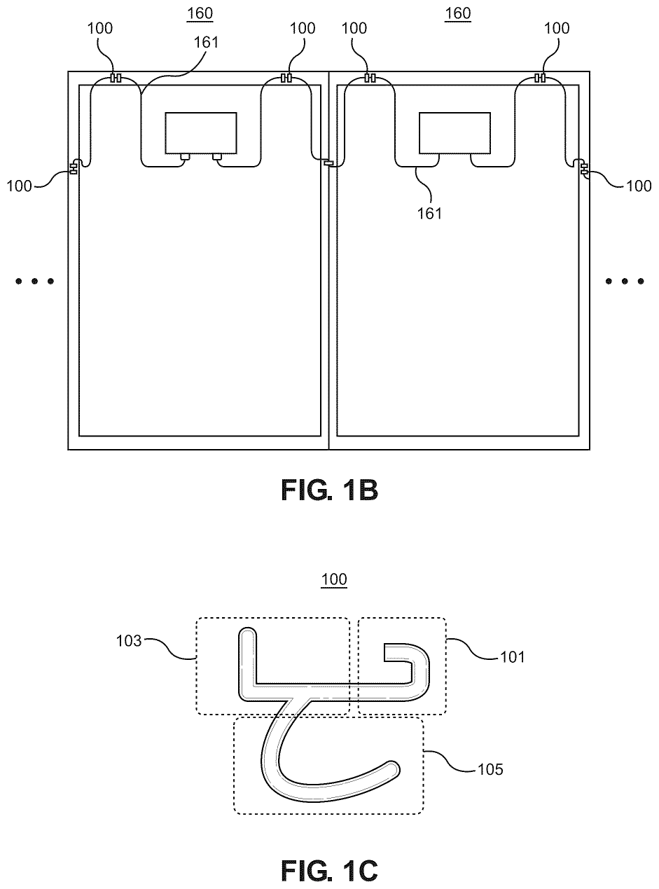

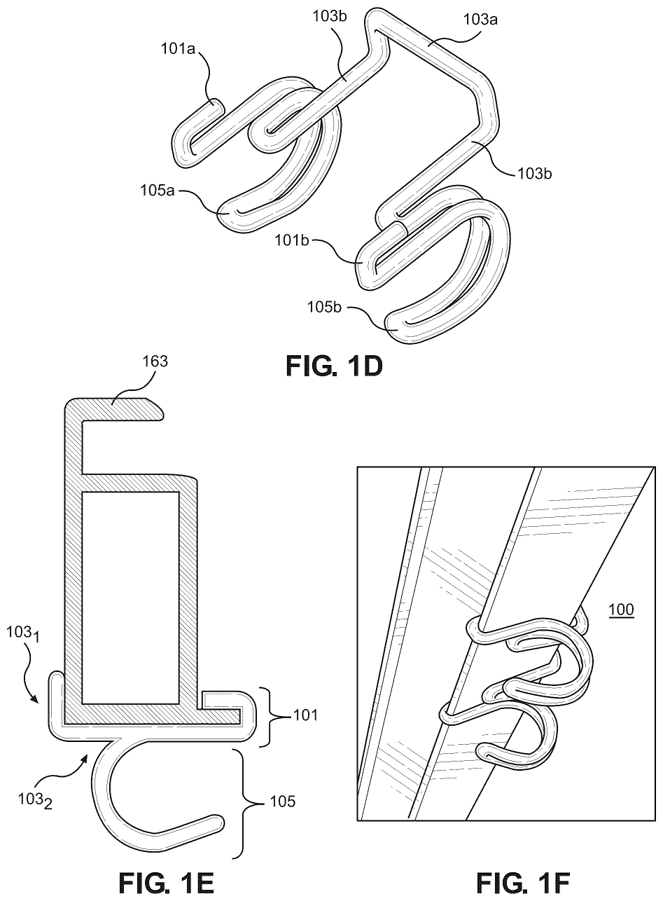

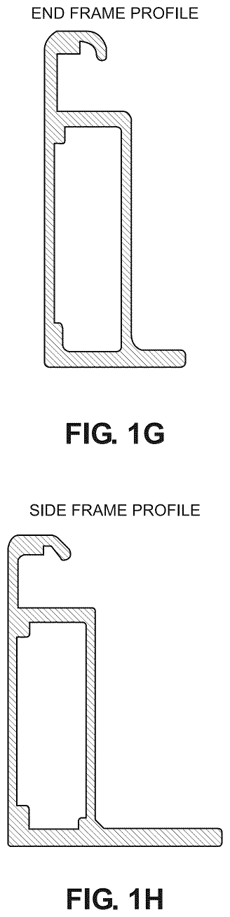

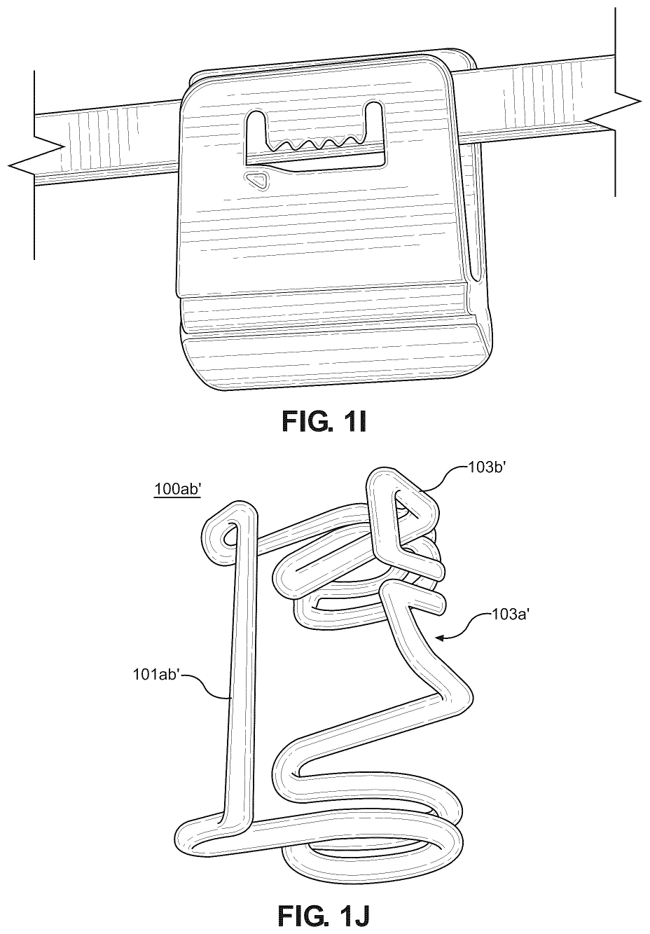

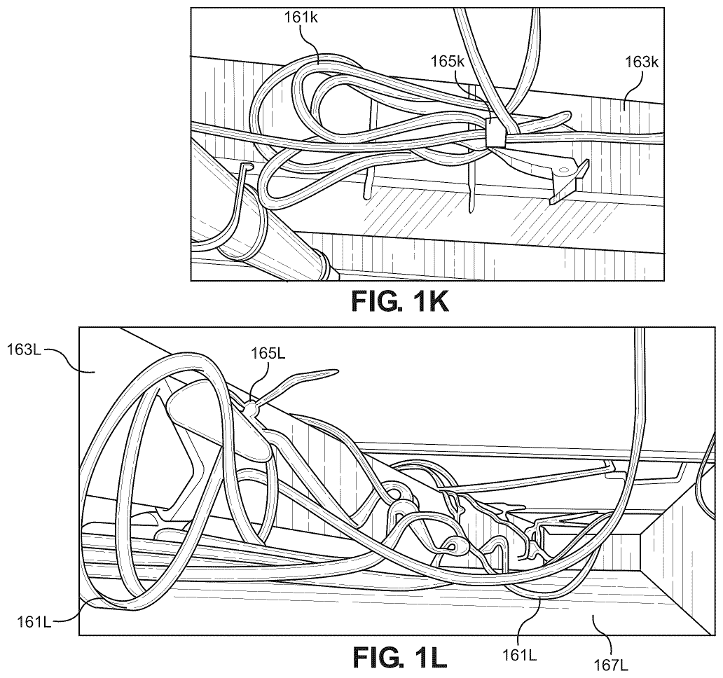

FIG. 1A illustrates an exemplary operating environment of photovoltaic modules 160 that utilize cable clips (e.g., 100 in 1B) for cable management according to one embodiment. FIG. 1A shows a residence 150 that includes photovoltaic modules 160. In one embodiment, the photovoltaic modules 160 utilize electrical energy generated by solar cells to supply the residence 150 with electricity that is used to power appliances 170 that are used at the residence 150. In one embodiment, the photovoltaic modules 160 use cable clips for cable management.

Referring to FIG. 1B, the photovoltaic modules 160 include cables 161 that include wires that carry electricity generated by the photovoltaic modules 160. Cables that are poorly managed can become sloppy and unsafe. In one embodiment, cable clips 100 can be used to manage photovoltaic module cables in a manner that is neat and safe.

FIGS. 1C and 1D show side and perspective views respectively of a photovoltaic module cable clip 100 according to one embodiment. Referring to FIGS. 1C and 1D, in one embodiment, the cable clip 100 can include a first portion 101 that includes flange fasteners 101a and 101b (see flange fasteners 101a and 101b in FIG. 1D) that are configured to fasten to a flange of a frame of a photovoltaic module, a second portion 103 that includes a frame wall fastener 103a and frame bottom fasteners 103b (see frame wall fastener 103a and frame bottom fasteners 103b in FIG. 1D) that are configured to fasten to an outside wall, and a bottom, of the frame of the photovoltaic module respectively, and a third portion 105 that includes cable hooks 105a and 105b (see cable hooks 105a and 105b in FIG. 1D) that extend underneath the first portion and the second portion and are configured to accommodate a cable.

FIG. 1E shows a cross sectional view of the cable clip 100 fastened to a frame of a photovoltaic module. Referring to FIG. 1E, in one embodiment, the first portion 101 is configured to contact three sides of the flange of the photovoltaic module. For example, FIG. 1E shows that the first portion 101 includes a part that contacts the top side of the flange, the face of the flange and the bottom side of the flange (see bracket associated with the first portion 101). In one embodiment, the first portion 101 is formed by shaping a portion of the wire to fit around the top side of the flange, the face of the flange and the bottom side of the flange firmly and securely.

In one embodiment, the second portion 103 is configured to include a part 103₁ that extends vertically up the outside wall of the frame of the photovoltaic module 160 and a part 103₂ that is fastened to a bottom surface of the frame of the photovoltaic module 160. In one embodiment, the part 103₁ of the second portion 103 that extends up the outside wall of the frame works cooperatively with the first portion 101, which snugly attaches the flange on the opposing side of the frame, to provide a clamping force that fastens the clip 100 to the frame.

In one embodiment, when the clip 100 is in place, the part 103₂ fastens to the bottom surface of the frame with a length that is configured to ensure that the parts of the clip 100 located on opposing sides of the clip 100 snugly and firmly clamp the opposing sides of the photovoltaic module frame.

In one embodiment, the third portion 105 is configured to partially surround the photovoltaic module cable 161 (hereinafter “the cable 161”). In one embodiment, to mount the cable 161, the cable 161 can be fit through a space that the third portion is configured to provide. In one embodiment, the third portion 105 can include a plurality of components that are configured to partially surround the cable. In one embodiment, the third portion 105 can include a plurality of hook shaped components. In other embodiments, the third portion 105 can have other shapes. FIG. 1F shows a view of the cable clip 100 fastened to the underside of the photovoltaic module frame.

In one embodiment, cable clip 100 can engage very short frame flanges (such as are associated with the short frame profile shown in FIG. 1G; a long frame profile is shown in FIG. 1H) in contrast to conventional clips which need a minimum frame flange to engage. This capability is useful as short flanges are increasingly employed for purposes of reducing module cost. In addition, because the cable clip 100 can be fabricated at low cost, the excessive cost needed to fabricate conventional steel clips can be avoided. FIG. 1I shows a conventional cable clip that uses a precarious pinch like hold on a short flange. This contrasts with the firm hold provided by cable clip 100 which can surround short flanges and clamp the side walls of frames. In one embodiment, the cable clip 100 can be formed without a dedicated tool, using much less material, and having a unit price that is much less than that of some conventional cable clips.

Although FIGS. 1C-1F show details of one embodiment, this embodiment is not intended to limit the scope of the present disclosure as features provided in the disclosure are intended to be illustrative rather than restrictive unless stated otherwise. For example, the description is intended to cover alternatives, modifications, and equivalents such as cable clip 100ab′ shown in FIG. 1J which is formed such that flange fastener 101ab′ does not include separate parts and the frame wall fasteners 103a′ and 103b′ are separate.

In operation, photovoltaic modules 160 can include cables 161 that can be exposed to elements such as sun, rain and wind. Moreover, cables 161 if not properly managed can be exposed to sharp edges that can be the source of abrasions and/or other types of damage. Additionally, hanging cables can attract animals that can cause damage to the cables. FIGS. 1K and 1L show hanging cables that have not been managed in a manner that prevents their exposure to damage. For example, FIGS. 1K and 1L show sloppily secured cables 161K and 161L attached to module frames 163K and 163L by cable ties 165K and 165L. In FIG. 1L sloppily secured cables 161L are shown as contacting surface 167L in a manner that can lead to damage. In contrast, referring again to FIG. 1B, when used to secure cables 161, cable clips 100 secure photovoltaic module cables in a manner that is neat and orderly, which is critical to the productivity, longevity and safety of photovoltaic modules. The operation of cable clips 100 in properly securing photovoltaic module cables protects cables 161 from sun, rain and wind as well as sharp abrasions and edges. It also eliminates hanging wires that attract animals that can chew on the hanging cables and cause damage. As shown in FIG. 1L, when cables are not properly managed, they can contact roof surfaces which can raise the potential that protective coatings and insulating layers that are used to cover the cables are compromised. Utilizing cable clip 100, as described herein prevents unmanaged cables from blowing in the wind and rubbing against rough surfaces in a manner that causes ground faults, loss in power or dangerous conditions such as arc faults.

Thus, using cable clips 100, cables can be secured in a manner that avoids damage to both its insulation and wire components, by avoiding sharp edges, rough surfaces, moving parts, direct sunlight and overly tight bends.

It should be appreciated that using cable clips 100, the thermocycling that causes movement of the photovoltaic module or its parts which can cause movement of cables, can be managed. For example, clips 100 can be used in climates, even where early morning temperature is substantially cooler than midday temperature. Clips 100 overcome the deficiencies of conventional approaches as the effects of thermocycling that can cause zip ties to break (as zip ties can become brittle), sharp edges to damage metal clips and cables, and connectors to slowly separate, can be avoided. It should be appreciated that although zip ties are inexpensive, they may not be sufficiently robust to last for the life of a photovoltaic module.

Large scale solar projects involve additional considerations as regards cable management. In large scale projects where there can be more cable, there can be more moveable elements and increased movement. In one embodiment, cable clips 100 can be used in such projects to safely manage cables despite such increased cable management challenges.

It should be appreciated that large scale projects operate at much higher voltages than residential installations. In particular, solar arrays in such environments can operate at voltages in excess of 1,500 V and amperages greater than 500 A. In some environments such voltages/amperages can present a risk of shock. In one embodiment, in such environments, cable clips 100 can be used to secure cables in a manner that adheres to strict safety procedures. In one embodiment, solar panels can operate at voltages up to 1,500 V. In other embodiments, solar panels can operate at voltages in excess of 1,500 V.

In one embodiment, cable clips 100 can be fastened to the framing structure of photovoltaic modules in a manner that not only protects cables from damage throughout the life of the system, but that also provides neat aesthetics. Consequently, in one embodiment, the operation of the cable clips 100 can extend the operational lifetime of PV systems by slowing or preventing degradation and/or failure of photovoltaic module cables, and their capacity to generate power without failure over a predetermined period of time.

### Method for Forming Wire Clip

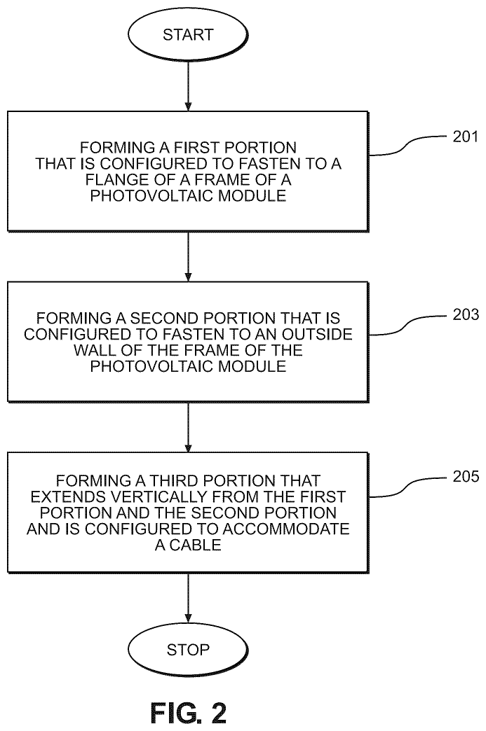

FIG. 2 shows a method of forming photovoltaic module cable clip according to one embodiment. At 201, forming a first portion that is configured to fasten to a flange of a frame of a photovoltaic module. At 203, forming a second portion that is configured to fasten to an outside wall of the frame of the photovoltaic module. And, at 205, forming a third portion that extends vertically from the first portion and the second portion and is configured to accommodate a cable. In one embodiment, the first portion is configured to contact three sides of the flange of the photovoltaic module. In one embodiment, the second portion is configured to extend vertically up the outside wall of the frame of the photovoltaic module. In one embodiment, the second portion is further configured to fasten to a bottom surface of the frame of the photovoltaic module. In one embodiment, the third portion is configured to partially surround the cable. In one embodiment, the third portion includes a plurality of components that are configured to partially surround the cable. In one embodiment, the third portion is hook shaped.

The following examples pertain to further embodiments. The various features of the different embodiments may be variously combined with some features included and others excluded to suit a variety of different applications.

Example embodiment 1: A photovoltaic module cable clip, including a first portion that is configured to fasten to a flange of a frame of a photovoltaic module; a second portion that is configured to fasten to an outside wall of the frame of the photovoltaic module; and a third portion that extends vertically from the first portion and the second portion and is configured to accommodate a cable.

Example embodiment 2: The photovoltaic module cable clip of example embodiment 1, wherein the first portion is configured to contact three sides of the flange of the photovoltaic module.

Example embodiment 3: The photovoltaic module cable clip of example embodiment 1, wherein the second portion is configured to extend vertically up the outside wall of the frame of the photovoltaic module.

Example embodiment 4: The photovoltaic module cable clip of example embodiment 1, wherein the second portion is further configured to fasten to a bottom surface of the frame of the photovoltaic module.

Example embodiment 5: The photovoltaic module cable clip of example embodiment 1, wherein the third portion is configured to partially surround the cable.

Example embodiment 6: The photovoltaic module cable clip of example embodiment 1, wherein the third portion includes a plurality of components that are configured to partially surround the cable.

Example embodiment 7: The photovoltaic module cable clip of example embodiment 1, wherein the third portion is hook shaped.

Example embodiment 8: A photovoltaic module, including a plurality of solar cells; a frame that is coupled to the solar cells; one or more cables coupled to the photovoltaic module; and a plurality of cable clips fastening the one or more cables to the photovoltaic module wherein the photovoltaic module cable clip comprises: a first portion that is configured to fasten to a flange of a frame of a photovoltaic module; a second portion that is configured to fasten to an outside wall of the frame of the photovoltaic module; and a third portion that extends vertically from the first portion and the second portion and is configured to accommodate a cable.

Example embodiment 9: The photovoltaic module of example embodiment 8, wherein the first portion is configured to contact three sides of the flange of the photovoltaic module.

Example embodiment 10: The photovoltaic module of example embodiment 8, wherein the second portion is configured to extend vertically up the outside wall of the frame of the photovoltaic module.

Example embodiment 11: The photovoltaic module of example embodiment 8, wherein the second portion is further configured to fasten to a bottom surface of the frame of the photovoltaic module.

Example embodiment 12: The photovoltaic module of example embodiment 8, wherein the third portion is configured to partially surround the cable.

Example embodiment 13: The photovoltaic module of example embodiment 8, wherein the third portion includes a plurality of components that are configured to partially surround the cable.

Example embodiment 14: The photovoltaic module of example embodiment 8, wherein the third portion is hook shaped.

Example embodiment 15: A method of forming photovoltaic module cable clip, including: forming a first portion that is configured to fasten to a flange of a frame of a photovoltaic module; forming a second portion that is configured to fasten to an outside wall of the frame of the photovoltaic module; and forming a third portion that extends vertically from the first portion and the second portion and is configured to accommodate a cable.

Example embodiment 16: The method of forming a photovoltaic module cable clip of example embodiment 15, wherein the first portion is configured to contact three sides of the flange of the photovoltaic module.

Example embodiment 17: The method of forming a photovoltaic module cable clip of example embodiment 15, wherein the second portion is configured to extend vertically up the outside wall of the frame of the photovoltaic module.

Example embodiment 18: The method of forming a photovoltaic module cable clip of example embodiment 15, wherein the second portion is further configured to fasten to a bottom surface of the frame of the photovoltaic module.

Example embodiment 19: The method of forming a photovoltaic module cable clip of example embodiment 15, wherein the third portion is configured to partially surround the cable.

Example embodiment 20: The method of forming a photovoltaic module cable clip of example embodiment 15, wherein the third portion includes a plurality of components that are configured to partially surround the cable.

Example embodiment 21: The method of forming a photovoltaic module cable clip of example embodiment 15, wherein the third portion is hook shaped.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of the present application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The various features of the different embodiments may be variously combined with some features included and others excluded to suit a variety of different applications.

What is claimed is:

1. A photovoltaic module cable clip, comprising:
a first portion that is configured to fasten to a flange of a frame of a photovoltaic module;
a second portion that is configured to fasten to an outside wall of the frame of the photovoltaic module; and
a third portion that extends vertically from the first portion and the second portion that is configured to accommodate a cable.

2. The photovoltaic module cable clip of claim 1, wherein the first portion is configured to contact three sides of the flange of the photovoltaic module.

3. The photovoltaic module cable clip of claim 1, wherein the second portion is configured to extend vertically up the outside wall of the frame of the photovoltaic module.

4. The photovoltaic module cable clip of claim 1, wherein the second portion is further configured to fasten to a bottom surface of the frame of the photovoltaic module.

5. The photovoltaic module cable clip of claim 1, wherein the third portion is configured to partially surround the cable.

6. The photovoltaic module cable clip of claim 1, wherein the third portion includes a plurality of components that are configured to partially surround the cable.

7. The photovoltaic module cable clip of claim 1, wherein the third portion is hook shaped.

8. A photovoltaic module, comprising:
a plurality of solar cells;
a frame that is coupled to the solar cells;
one or more cables coupled to the photovoltaic module; and
a plurality of cable clips fastening the one or more cables to the photovoltaic module wherein the plurality of cable clips comprises:
a first portion that is configured to fasten to a flange of the frame;
a second portion that is configured to fasten to an outside wall of the frame of the photovoltaic module; and
a third portion that extends vertically from the first portion and the second portion that is configured to accommodate the one or more cables.

9. The photovoltaic module of claim 8, wherein the first portion is configured to contact three sides of the flange of the photovoltaic module.

10. The photovoltaic module of claim 8, wherein the second portion is configured to extend vertically up the outside wall of the frame of the photovoltaic module.

11. The photovoltaic module of claim 8, wherein the second portion is further configured to fasten to a bottom surface of the frame of the photovoltaic module.

12. The photovoltaic module of claim 8, wherein the third portion is configured to partially surround the cable.

13. The photovoltaic module of claim 8, wherein the third portion includes a plurality of components that are configured to partially surround the one or more cables.

14. The photovoltaic module of claim 8, wherein the third portion is hook shaped.

15. A method of forming photovoltaic module cable clip, comprising:
forming a first portion that is configured to fasten to a flange of a frame of a photovoltaic module;
forming a second portion that is configured to fasten to an outside wall of the frame of the photovoltaic module; and
forming a third portion that extends vertically from the first portion and the second portion that is configured to accommodate a cable.

16. The method of forming the photovoltaic module cable clip of claim 15, wherein the first portion is configured to contact three sides of the flange of the photovoltaic module.

17. The method of forming the photovoltaic module cable clip of claim 15, wherein the second portion is configured to extend vertically up the outside wall of the frame of the photovoltaic module.

18. The method of forming the photovoltaic module cable clip of claim 15, wherein the second portion is further configured to fasten to a bottom surface of the frame of the photovoltaic module.

19. The method of forming the photovoltaic module cable clip of claim 15, wherein the third portion is configured to partially surround the cable.

20. The method of forming the photovoltaic module cable clip of claim 15, wherein the third portion includes a plurality of components that are configured to partially surround the cable.
